(19) United States
(12) Patent Application Publication
(10) Pub. No.: US 2018/0343245 A1
(43) Pub. Date: Nov. 29, 2018

(54) TERMINAL FOR USE IN SINGLE SIGN-ON (SSO) AUTHENTICATION SYSTEM

(71) Applicant: The Bank of Tokyo-Mitsubishi UFJ, Ltd., Tokyo (JP)

(72) Inventor: Koji MIZUTANI, Tokyo (JP)

(21) Appl. No.: 15/603,656

(22) Filed: May 24, 2017

(51) Int. Cl. H04L 29/06

(52) U.S. Cl. CPC H04L 63/0815

(57) ABSTRACT

A terminal for use in a SSO authentication system in accordance with a SAML (Security Assertion Markup Language) scheme is disclosed. One aspect of the present invention relates to a terminal including an authentication processing unit configured to access an authentication server to establish a session for accessibility to one or more service servers, and a service processing unit configured to, in response to the session being established, access the service servers, wherein when the service processing unit accesses one of the service servers, the authentication processing unit transmits a dummy authentication request to the authentication server.

### BACKGROUND OF THE INVENTION

### 1. Field of the Invention

The disclosures herein generally relate to session management techniques for single sign-on (hereinafter, SSO) authentication systems.

### 2. Description of the Related Art

Presently, various web services are provided from web servers on the Internet. Some of the web servers may provide their web services to all users in an access free manner while other web servers may provide them to a limited number of users. In the latter case, the users have to be authenticated by authentication functionalities installed in the web servers or separate authentication servers.

Meanwhile, cloud computing techniques are widely used in the recent years. In a cloud computing system, various computing resources such as networks, servers and storages are shared by multiple users. In the cloud computing systems, SSO (Single Sign-On) authentication scheme is often used to authenticate users. In the SSO authentication scheme, once a user is authenticated by an SSO authentication system server, for example, the authenticated user is allowed to access one or more service servers under the control of the SSO authentication system server without need of the user being individually authenticated by the service servers. According to the above SSO authentication scheme, if the user is initially authenticated by the SSO authentication system server, the user does not have to input authentication information such as a user ID and a password at accessing the individual service servers.

As typical schemes to access the service servers for use in the SSO authentication system, a reverse proxy scheme and a SAML (Security Assertion Markup Language) scheme are known. In the reverse proxy scheme, as illustrated in FIG. 1, if a terminal 100 is initially authenticated by a SSO authentication system server 200 to establish a session for the terminal 100 to use the service servers 300 under the control of the SSO authentication system server 200, the terminal 100 can access service servers 300A, 300B and 300C (which may be collectively referred to as service servers 300 hereinafter) via the SSO authentication system server 200 without need of being authenticated by the service servers 300 individually. Then, whenever the terminal 100 accesses any of the service servers 300 in the established session, the SSO authentication system server 200 resets its own session management timer for the terminal 100. The session management timer is used to timeout or release the session that has not been used for a predetermined period. As a result, as long as the terminal 100 is using any of the service servers 300 via the SSO authentication system server 200, the SSO authentication system server 200 resets the session management timer, and the terminal can access the other service servers 300 without need of authentication.

In the SAML scheme, on the other hand, as illustrated in FIG. 2, upon the terminal 100 is initially authenticated by the SSO authentication system server 200 to establish a session for the terminal 100 to use the service servers 300 under the control of the SSO authentication system server 200, the terminal 100 can access any of the service servers 300 directly without via the SSO authentication system server 200. In this case, when the terminal 100 accesses any of the service servers 300 in the established session, the SSO authentication system server 200 cannot know that the terminal 100 has accessed the service servers 300 and accordingly cannot reset the session management timer even if the terminal 100 is using the session with ones of the service servers 300. As a result, even if the terminal 100 is using any of the service servers 300, there is a likelihood that the session management timer may expire at the SSO authentication system server 200, and accordingly the terminal 100 cannot access ones of service servers 300 other than the presently used service servers 300 after expiration of the session management timer at the SSO authentication system server 200.

### SUMMARY OF THE INVENTION

In light of the above problem, one object of the present invention is to provide an appropriate session management scheme for the SSO authentication system.

One aspect of the present invention relates to a terminal, including: an authentication processing unit configured to access an authentication server to establish a session for accessibility to one or more service servers; and a service processing unit configured to, in response to the session being established, access the service servers, wherein when the service processing unit accesses one of the service servers, the authentication processing unit transmits a dummy authentication request to the authentication server.

Another aspect of the present invention relates to a recording medium for storing a program for causing a computer to: accessing an authentication server to establish a session for accessibility to one or more service servers; and in response to the session being established, accessing the service servers, wherein when one of the service servers is accessed, the accessing comprises transmitting a dummy authentication request to the authentication server.

Other objects and further features of the present invention will be apparent from the following detailed description when read in conjunction with the accompanying drawings.

### BRIEF DESCRIPTION OF THE DRAWINGS

FIG. 1 is a schematic diagram for illustrating an exemplary access by a terminal to service servers in accordance with a reverse proxy scheme in an SSO authentication system;

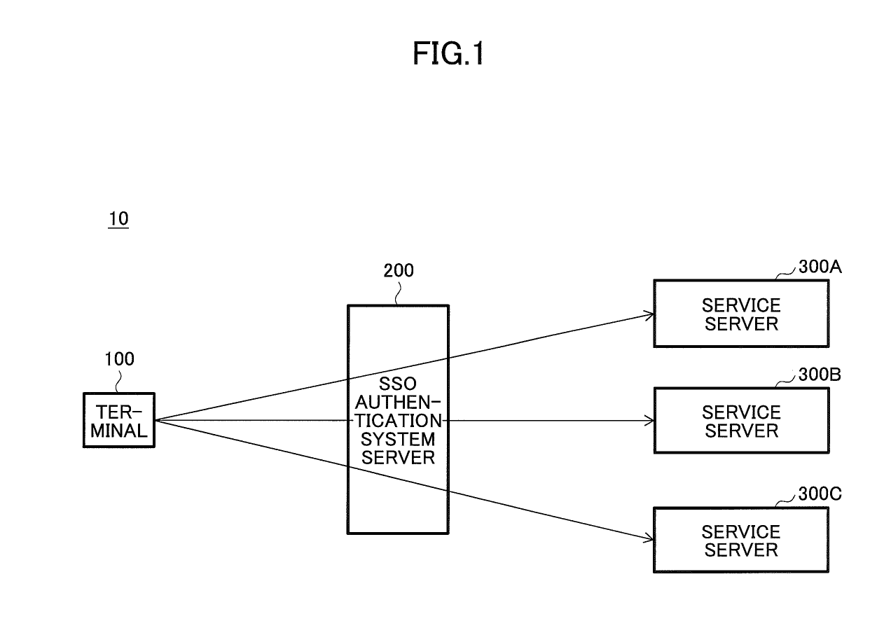

FIG. 2 is a schematic diagram for illustrating an exemplary access by the terminal to the service servers in accordance with a SAML scheme in the SSO authentication system;

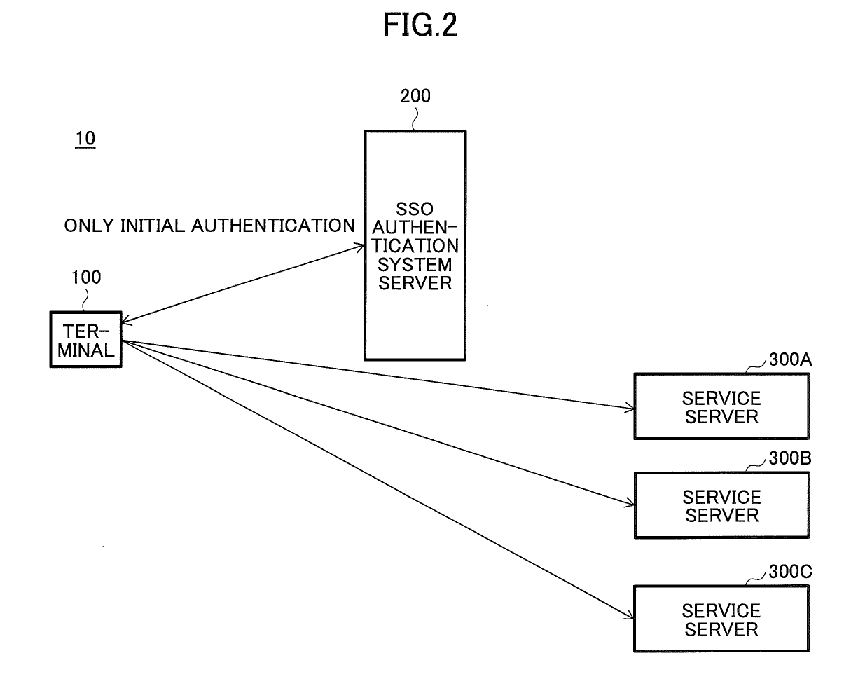

FIG. 3 is a schematic diagram for illustrating an exemplary access by the terminal to the service servers in the SSO authentication system according to one embodiment of the present invention;

FIG. 4 is a block diagram for illustrating an exemplary hardware arrangement of the terminal according to one embodiment of the present invention;

FIG. 5 is a block diagram for illustrating an exemplary functional arrangement of the terminal according to one embodiment of the present invention; and

FIG. 6 is a sequence diagram for illustrating an exemplary session management in the SSO authentication system according to one embodiment of the present invention.

### DESCRIPTION OF THE PREFERRED EMBODIMENTS

In the following, embodiments of the present invention will be described with reference to the accompanying drawings. In these drawings, the same or similar elements are referred to by the same or similar numerals, and a description thereof will be omitted as appropriate.

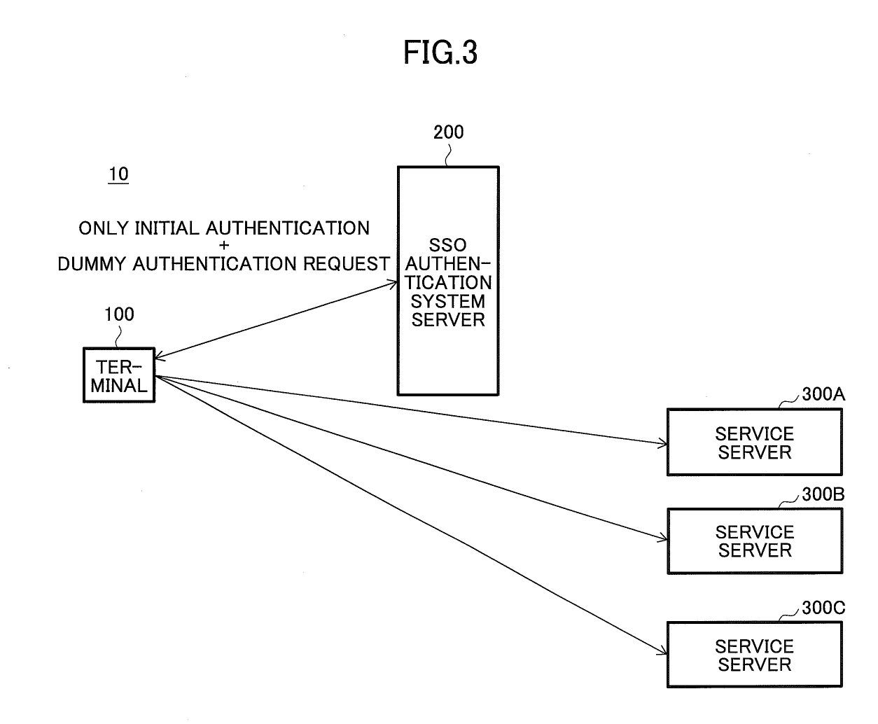

In embodiments as stated below, a terminal for use in a SSO authentication system is disclosed. According to the embodiments, as illustrated in FIG. 3, a SSO authentication system 10 has a terminal 100, a SSO authentication system server 200 and one or more service servers 300. In order to obtain accessibility to one or more service servers 300 under the control of the SSO authentication system server 200, the terminal 100 has to be initially authenticated by a SSO authentication system server 200. Upon the authentication being successful, a session between the terminal 100 and the service servers 300 is established by the SSO authentication system server 200, and the terminal 100 is allowed to directly access the service servers 300 without via the SSO authentication system server 200. After that, whenever the terminal 100 transmits a service request to access any of the service servers 300, the terminal 100 further transmits a dummy authentication request to the SSO authentication system server 200 to cause the SSO authentication system server 200 to reset its own session management timer. Upon receiving the dummy authentication request, the SSO authentication system server 200 resets the session management timer so that the session can be prolonged. In this manner, the session between the terminal 100 and the service servers 300 can be appropriately prolonged and managed even in the SAML scheme where the terminal 100 communicates with the service servers 300 directly without via the SSO authentication system server 200.

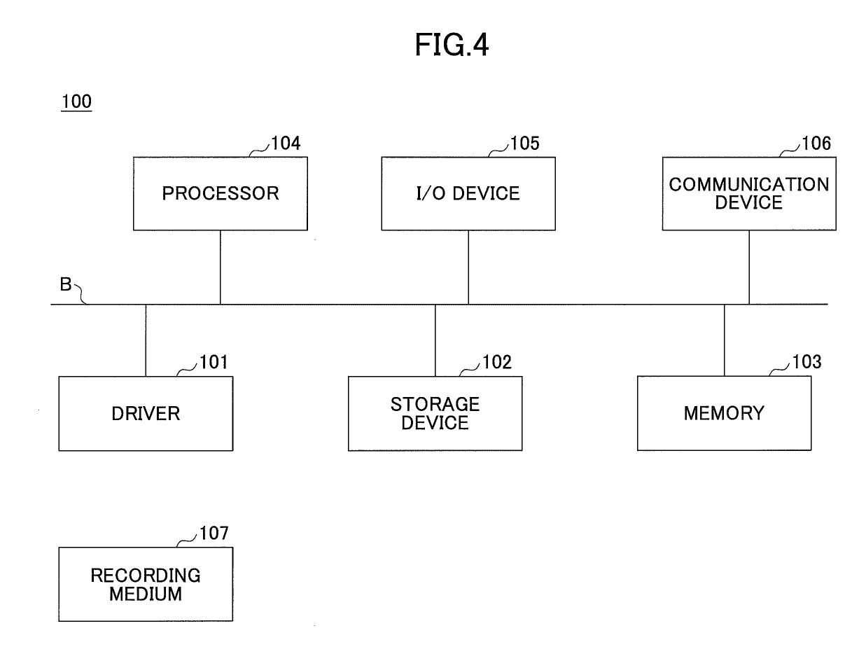

FIG. 4 is a block diagram for illustrating an exemplary hardware arrangement of the terminal 100 according to one embodiment of the present invention.

Typically, the terminal 100 may be any type of information processing apparatus with communication functionalities such as a personal computer (PC), a smartphone, a tablet and a handheld device. As illustrated in FIG. 4, the terminal 100 may be composed of a driver 101, a storage device 102, a memory 103, a processor 104, an input and output (I/O) device 105 and a communication device 106, which are coupled to each other via a bus B.

Computer programs including programs for implementing various functionalities and operations of the terminal 100 as stated below may be provided from any type of recording media 107 such as a CD-ROM (Compact Disc-Read Only Memory), a DVD-ROM (Digital Versatile Disc-Read Only Memory) or a flash memory. When the recording medium 107 having the programs is loaded into the driver 101, the programs may be installed from the recording medium 107 to the storage device 102 via the driver 101. However, the programs are unnecessarily installed from the recording medium 107 and may be downloaded from any external device via a network.

The storage device 102 stores the installed programs as well as necessary files and data. Upon receiving an activation instruction for the programs, the memory 103 reads and stores the programs and data from the storage device 102. The CPU 104 performs various functionalities and operations of the terminal 100 as described in detail below in accordance with various data such as parameters stored in the memory 103. The I/O device 105 serves as interfaces with users and peripheral devices. The communication device 106 performs various communication operations to communicate with external devices and networks. However, the terminal 100 is not limited to the above-stated hardware arrangement and may be implemented by any other appropriate information processing system.

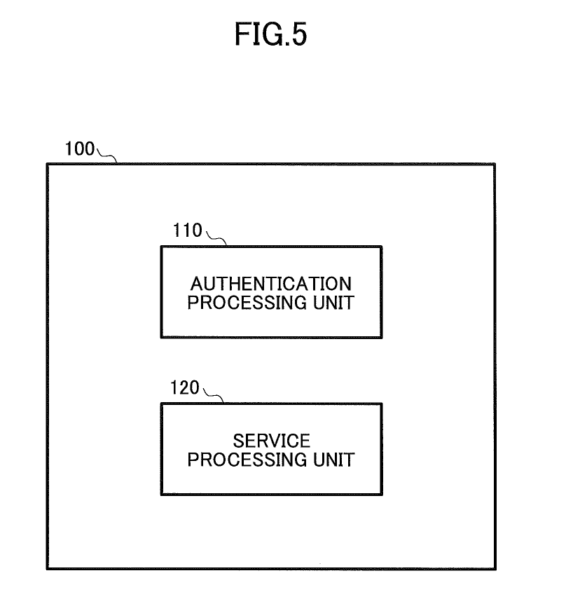

Next, the terminal according to one embodiment of the present invention is described with reference to FIG. 5. As stated above with reference to FIG. 3, the terminal 100 according to this embodiment is initially authenticated by the SSO authentication system server 200 to access the service servers 300. Once the terminal 100 is authenticated by the SSO authentication system server 200 to establish a session for accessibility to the service servers 300, the terminal 100 is allowed to directly communicate with the service servers 300 without via the SSO authentication system server 200 in accordance with the above-stated SAML scheme. When the terminal 100 accesses any of the service servers 300, the terminal 100 not only communicates with that service server 300 but also transmits a dummy authentication request to the SSO authentication system server 200 to cause the established session to be prolonged. Upon receiving the dummy authentication request from the terminal 100, the SSO authentication system server 200 prolongs the session by resetting a session management timer for the session, for example. Accordingly, even after passage of a predetermined expiration period from the initial activation of the session management timer, the session management timer can be reset or updated at the SSO authentication system server 200, and the terminal 100 can retain the accessibility to ones of the service servers 300 that have not yet accessed after the initial session establishment.

FIG. 5 is a block diagram for illustrating a functional arrangement of the terminal according to one embodiment of the present invention.

As illustrated in FIG. 5, the terminal 100 has an authentication processing unit 110 and a service processing unit 120.

The authentication processing unit 110 accesses the SSO authentication system server 200 to establish a session for accessibility to one or more service servers 300. Specifically, when the terminal 100 attempts to access the service server 300, the terminal 100 is requested to be authenticated by the SSO authentication system server 200 to establish a session to access the service servers 300 under the control of the SSO authentication system server 200. For the authentication, the authentication processing unit 110 may transmit authentication information, such as a login ID and a password, to the SSO authentication system server 200. Once the terminal 100 has been successfully authenticated based on the provided authentication information, the terminal 100 is allowed to access the service servers 300 directly in accordance with the SAML scheme, that is, without via the SSO authentication system server 200, as illustrated in FIG. 3.

In response to the session being established, the service processing unit 120 accesses the service servers 300. For example, if the user desires a certain web service, the service processing unit 120 transmits service requests to one or more of the service servers 300 associated with the desired web service to exchange data with the associated service servers 300. In other words, in the SAML scheme, once the session is successfully established, the service processing unit 120 is allowed to access the service servers 300 without need of communicating with the SSO authentication system server 200.

Also, according to this embodiment, when the service processing unit 120 transmits the service requests to one of the service servers 300, the authentication processing unit 110 further transmits a dummy authentication request to the SSO authentication system server 200 to cause the current session to be prolonged.

Typically, the SSO authentication system server 200 has a session management timer to manage the current session. If the session management timer expires, the SSO authentication system server 200 releases the session, after which the terminal 100 cannot access the service server 300 under the control of the SSO authentication system server 200. When the SSO authentication system server 200 receives the dummy authentication request transmitted from the terminal 100, for example, at every access to any of the service servers 300, the SSO authentication system server 200 may accordingly reset the session management timer to prolong the session. In other words, the dummy authentication request may serve to prolong a period of validity for the session.

In the above-stated embodiment, whenever the service processing unit 120 accesses any of the service servers 300, the authentication processing unit 110 transmits the dummy authentication request to the SSO authentication system server 200, but the present invention is not limited to it. In other embodiments, the authentication processing unit 110 may transmit the dummy authentication request to the SSO authentication system server 200 in a synchronous or asynchronous manner to the service servers 300. For example, the authentication processing unit 110 may transmit the dummy authentication request to the SSO authentication system server 200 during communication with any of the service servers 300 only immediately before the session management timer expires at the SSO authentication system server 200, for example, only in a predetermined period before expiration of the session management timer at the SSO authentication system server 200. Specifically, the authentication processing unit 110 may transmit the dummy authentication request to the SSO authentication system server 200 only at the last one minute of the period of validity of the session management timer. According to this embodiment, the authentication processing unit 110 has to transmit the dummy authentication request to the SSO authentication system server 200 fewer times, which can reduce signaling overhead.

Also, even though the authenticating processing unit 110 controls different expiries within which the terminal effectively communicates to the SSO authentication system server 200 and/or the service servers 300 at the present, the dummy authentication request makes the next different expiries become almost coincident. Therefore, the SSO authentication system 10 allows a user's operation for authentication requests by the terminal 100 to be easier.

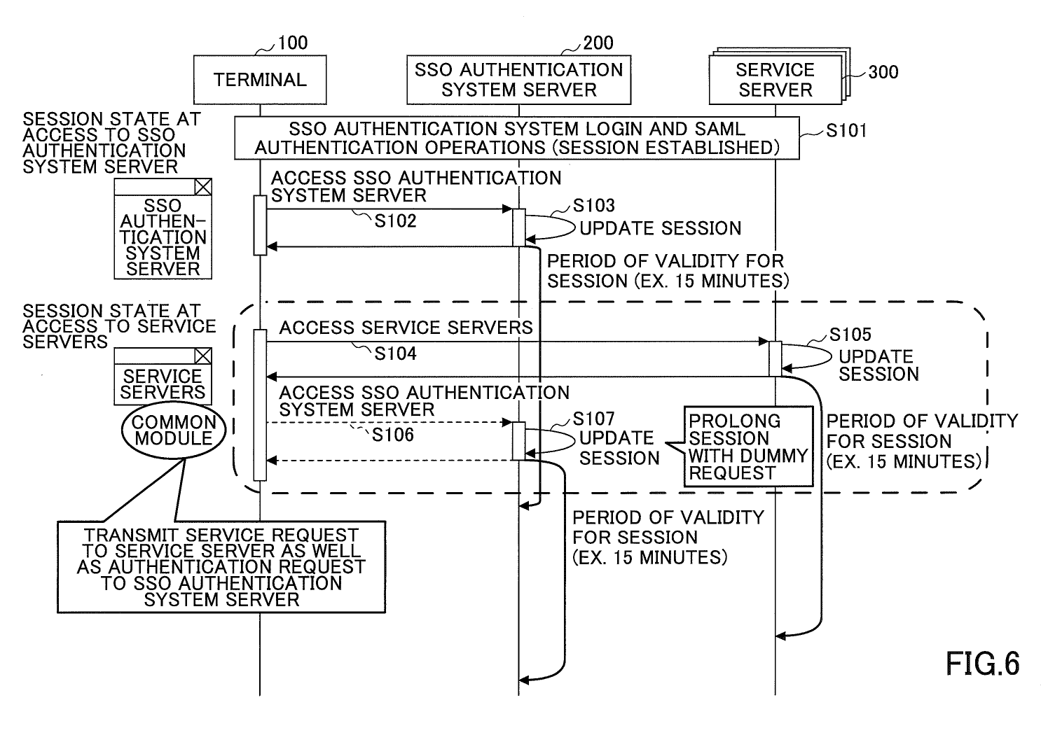

Next, the SSO authentication system according to one embodiment of the present invention is described with reference to FIG. 6. In the SSO authentication system 10 according to this embodiment, the terminal 100, the SSO authentication system server 200 and the service servers 300 may exchange with each other in a session established by the SSO authentication system server 200 as follows. FIG. 6 is a sequence diagram for illustrating an exemplary session management operation in the SSO authentication system according to one embodiment of the present invention.

As illustrated in FIG. 6, at step S101, the terminal 100 performs login operations to the SSO authentication system 10 to obtain accessibility to the service servers 300 in accordance with the SAML scheme.

At step S102, the terminal 100 accesses the SSO authentication system server 200 to obtain accessibility to the service servers 300 in the control of the SSO authentication system server 200. Specifically, as illustrated in FIG. 6, the user of the terminal 100 may be requested to input user's authentication information, such as the user's login ID and a password, at a web page served by the SSO authentication system server 200. If the terminal 100 is successfully authenticated by the SSO authentication system server 200, a session between the terminal 100 and the service servers 300 in the control of the SSO authentication system server 200 is established by the SSO authentication system server 200 so that the terminal 100 can access the service servers 300. On the other hand, if the terminal 100 is not successfully authenticated, the SSO authentication system server 200 may promote the terminal 100 to retry to input the user's login ID and the password to the web page.

At step S103, if the terminal 100 is successfully authenticated, the SSO authentication system server 200 establishes the session for the terminal 100 and activates its own session management timer for the session. The session management timer may be set in advance to have a predetermined period of validity for the session, for example, 15 minutes. If the session management timer expires, the SSO authentication system server 200 determines that the terminal 100 has no longer used the session and releases the unnecessary session.

After the session has been established, the terminal is allowed to access the service servers 300 under the control of the SSO authentication system server 200, and at step S104, the terminal 100 accesses any of the service servers 300 directly in accordance with the SAML scheme, that is, without via the SSO authentication system server 200. Specifically, as illustrated in FIG. 6, the user of the terminal 100 may manipulate a web page provided from the service server 300 to use a desired web service served by the service server 300.

At step S105, the accessed service server 300 updates the session for the terminal 100. Specifically, the service server 300 may have its own session management timer and reset the session management timer for the terminal 100 so that the session can be prolonged.

In this case, however, the session management timer cannot be reset at the SSO authentication system server 200 in accordance with the SAML scheme, because the SSO authentication system server 200 does not know that the terminal 100 has accessed the service server 300. In order to avoid the situation where the session management timers may be mismatched between the SSO authentication system server 200 and the service servers 300, according to this embodiment, at step S106, the terminal 100 transmits a dummy authentication request to the SSO authentication system server 200 to cause the SSO authentication system server 200 to reset the session management timer in consistency with the prolonged session management timer at the service server 300.

For example, the terminal 100 may transmit the dummy authentication request synchronously or asynchronously with accessing the service server 300 at step S106. In the synchronous transmission, whenever the terminal 100 transmits service requests to any of the service servers 300, the terminal 100 may transmit the dummy authentication request to the SSO authentication system server 200 simultaneously or almost simultaneously. In the asynchronous transmission, on the other hand, the terminal 100 may not transmit the dummy authentication request to the SSO authentication system server 200 for every access to the service servers 300. For example, the terminal 100 may transmit the dummy authentication request to the SSO authentication system server 200, for example, every several accesses or only in a predetermined period before expiration of the session management timer at the SSO authentication system server 200.

At step S107, the SSO authentication system server 200 resets the session management timer so that the session can be prolonged in consistency with the prolonged session management timer at the service servers 300. As a result, the terminal 100 can access the not-yet-accessed service servers 300 other than the already accessed service servers 300 in the prolonged session.

Although the above embodiments have been described in conjunction with the SAML scheme, the present invention is not limited to it. It will be understood by those skilled in the art that the above embodiments can be easily applied or adapted to any other cases where session management timers may be inconsistent between the authentication server and the service servers.

Further, the present invention is not limited to these embodiments, but various variations and modifications may be made without departing from the scope of the present invention.

What is claimed is:

1. A terminal, comprising:
an authentication processing unit configured to access an authentication server to establish a session for accessibility to one or more service servers; and
a service processing unit configured to, in response to the session being established, access the service servers,
wherein when the service processing unit accesses one of the service servers, the authentication processing unit transmits a dummy authentication request to the authentication server.

2. The terminal as claimed in claim 1, wherein the dummy authentication request is to prolong a period of validity for the session.

3. The terminal as claimed in claim 1, wherein the authentication processing unit transmits the dummy authentication request to the authentication server synchronously with accessing the service servers.

4. The terminal as claimed in claim 1, wherein the authentication processing unit transmits the dummy authentication request to the authentication server asynchronously with accessing the service servers.

5. The terminal as claimed in claim 1, wherein the service servers are managed in a SAML (Security Assertion Markup Language) scheme, and once the session is established, the service processing unit is allowed to access the service servers without need of communicating with the authentication server.

6. A recording medium for storing a program for causing a computer to:
accessing an authentication server to establish a session for accessibility to one or more service servers; and
in response to the session being established, accessing the service servers,
wherein when one of the service servers is accessed, the accessing comprises transmitting a dummy authentication request to the authentication server.

7. An authentication computer system, comprising:
a first server configured to receive a first authentication request for which a terminal requests to establish a session; and
a second server configured to receive a second authentication request from the terminal when the first server receives the first authentication request synchronously or within an allowance of time.

8. The authentication computer system according to claim 7, wherein
the first server receives the first authentication request, while the second server maintains the session with the terminal.
